(19) United States
(12) Patent Application Publication
(10) Pub. No.: US 2013/0332166 A1
(43) Pub. Date: Dec. 12, 2013

(54) PROCESSING APPARATUS, PROCESSING SYSTEM, AND OUTPUT METHOD

(71) Applicants: Haruomi Higashi, Kanagawa (JP); Hideki Ohhashi, Kanagawa (JP); Takahiro Hiramatsu, Kanagawa (JP); Tomoyuki Tsukuda, Kanagawa (JP)

(72) Inventors: Haruomi Higashi, Kanagawa (JP); Hideki Ohhashi, Kanagawa (JP); Takahiro Hiramatsu, Kanagawa (JP); Tomoyuki Tsukuda, Kanagawa (JP)

(73) Assignee: RICOH COMPANY, LTD., Tokyo (JP)

(21) Appl. No.: 13/911,153

(22) Filed: Jun. 6, 2013

(30) Foreign Application Priority Data
Jun. 7, 2012 (JP) 2012-130168

(51) Int. Cl. G10L 15/00

(52) U.S. Cl. CPC G10L 15/00
USPC 704/246

(57) ABSTRACT

A processing apparatus includes: a voice recognition unit that recognizes a voice of a user; a condition recognition unit that recognizes a current condition of a user; a search result acquisition unit that acquires a search result searched on the basis of the voice recognized by the voice recognition unit; an output manner determination unit that determines a manner of outputting the search result on the basis of the current condition recognized by the condition recognition unit; and an output control unit that causes an output unit to output the search result acquired by the search result acquisition unit in the manner determined by the output manner determination unit.

### CROSS-REFERENCE TO RELATED APPLICATIONS

The present application claims priority to and incorporates by reference the entire contents of Japanese Patent Application No. 2012-130168 filed in Japan on Jun. 7, 2012.

### BACKGROUND OF THE INVENTION

1. Field of the Invention

The present invention relates to a processing apparatus, a processing system, and an output method.

2. Description of the Related Art

Conventionally, apparatuses have been known that have a conversation with persons. For example, Japanese Patent Application Laid-open No. 2010-186237 discloses an apparatus that determines contents and timing of utterance of an agent that is a computer in accordance with conditions of the conversation.

However, although the conventional conversation apparatuses take into consideration the conditions of conversation, they do not take into consideration external conditions such as topographical conditions of the user and the agent and the atmospheres around them. Accordingly, a problem arises in that a voice is output in a place where the voice output is inappropriate such as on a train or in a movie theater.

In view of such circumstances, there is a need to provide a processing apparatus, a processing system, and an output method that can provide a user with information in a provision manner fitting the user's condition.

### SUMMARY OF THE INVENTION

It is an object of the present invention to at least partially solve the problems in the conventional technology.

A processing apparatus includes: a voice recognition unit that recognizes a voice of a user; a condition recognition unit that recognizes a current condition of a user; a search result acquisition unit that acquires a search result searched on the basis of the voice recognized by the voice recognition unit; an output manner determination unit that determines a manner of outputting the search result on the basis of the current condition recognized by the condition recognition unit; and an output control unit that causes an output unit to output the search result acquired by the search result acquisition unit in the manner determined by the output manner determination unit.

A processing system includes: a voice recognition unit that recognizes a voice of a user; a condition recognition unit that recognizes a current condition of a user; a search result acquisition unit that acquires a search result searched on the basis of the voice recognized by the voice recognition unit; an output manner determination unit that determines a manner of outputting the search result on the basis of the current condition recognized by the condition recognition unit; and an output control unit that causes an output unit to output the search result acquired by the search result acquisition unit in the manner determined by the output manner determination unit.

An output method includes: recognizing a voice of a user; recognizing a current condition of a user; acquiring a search result searched on the basis of the voice recognized at the recognizing the voice; determining a manner of outputting the search result on the basis of the current condition recognized at the recognizing the current condition; and causing an output unit to output the search result acquired at the acquiring in the manner determined at the determining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary structure of a processing system;

FIG. 2 is a schematic diagram illustrating a data structure of a provision manner determination table; and

FIG. 3 is a flowchart illustrating an example of processing performed by the processing system.

### DETAILED DESCRIPTION OF THE PREFERRED EMBODIMENT

Embodiments of a processing apparatus, a processing system, and an output method are described below in detail with reference to the accompanying drawings.

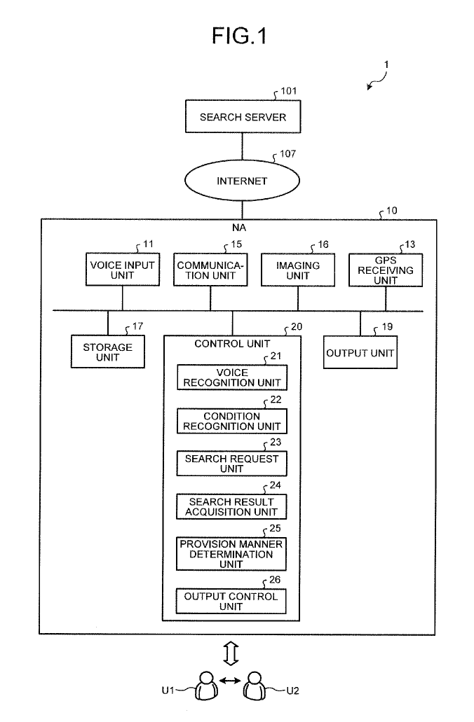

FIG. 1 is a block diagram illustrating an exemplary structure of a processing system 1 according to the present embodiment. As illustrated in FIG. 1, the processing system 1 includes a network agent (NA), which is as an example of the processing apparatus, and a search server 101. The NA 10 and the search server 101 are connected through the Internet 107.

The search server 101 is to search information published on the web, and may be a server that provides a search engine function on the web, for example. Specifically, the search server 101 receives a search query from the NA 10, searches information published on the web in accordance with the received search query, and transmits the search result to the NA 10. The information that the search server 101 searches may be dynamic information published on dynamic web pages or static information published on static web pages. In the example illustrated in FIG. 1, the single search server 101 is exemplarily illustrated. However, it is not limited thereto, and any number of servers may be included.

The NA 10 is a terminal that accesses information or functions published on the web. In the embodiment, it is assumed that the NA 10 is a mobile terminal such as a smartphone or a tablet. The NA 10, however, is not limited to the mobile terminal. Any device accessible to the Internet can be used as the NA 10.

In the embodiment, the description of the NA 10 (processing system 1) is made on the basis of an assumption that the user U1 has the NA 10 and uses the NA 10 for having conversation with the user U2. However, a user can use the NA 10 alone or more than two users can use the NA 10 in common.

The processing system 1 supports conversation between users U1 and U2 or the like using a web cloud including the search server 101. For example, when the users U1 and U2 have conversation about “where they are going to go in the Christmas season”, the NA 10 can receive a search result of “recommended places to visit in the Christmas season” from the web cloud and provide the users with the search result.

As illustrated in FIG. 1, the NA 10 includes a voice input unit 11, a global positioning system (GPS) receiving unit 13, a communication unit 15, an imaging unit 16, a storage unit 17, an output unit 19, and a control unit 20.

The voice input unit 11 is used to input voice of the user or the like to the NA 10 and can be realized by a sound collector such as a microphone. The GPS receiving unit 13 receives positional information indicating a location of the user. Specifically, the GPS receiving unit 13 receives radio waves from GPS satellites and can be realized by a GPS receiver or the like.

The communication unit 15 communicates with an external apparatus such as the search server 101 through the Internet 107 and can be realized by a communication device such as a network interface card (NIC). The imaging unit 16 takes an image of surrounding environment of the user of the NA 10 and can be realized by an imaging device such as a digital camera or a stereo camera.

The storage unit 17 stores therein various programs executed by the NA 10 and data used for various types of processing performed by the NA 10. The storage unit 17 can be realized by a storage device capable of magnetically, optically or electrically storing data, such as a hard disk drive (HDD), a solid state drive (SOD), a memory card, an optical disk, a read only memory (ROM), and a random access memory (RAM).

The output unit 19 outputs a processing result of the control unit 20 and may be realized by a display device for visual output such as a liquid crystal display and a touch panel display, an audio device for audio output such as a speaker, or the combination of the devices.

The control unit 20 controls the respective units of the NA 10 and includes a voice recognition unit 21, a condition recognition unit 22, a search request unit 23, a search result acquisition unit 24, a provision manner determination unit 25, and an output control unit 26. The voice recognition unit 21, the condition recognition unit 22, the search request unit 23, the search result acquisition unit 24, the provision manner determination unit 25, and the output control unit 26 may be realized by causing a processing unit such as a central processing unit (CPU) to execute a computer program, i.e., realized by software, by hardware such as an integrated circuit (IC), or by both of the software and the hardware.

The voice recognition unit 21 performs voice recognition processing on an input voice and obtains the voice recognition result. Specifically, the voice recognition unit 21 extracts a feature amount of a voice input from the voice input unit 11 and converts the extracted feature amount into a text (character string) using dictionary data for voice recognition stored in the storage unit 17. The detailed description of the voice recognition technique is omitted because the known techniques disclosed in such as Japanese Patent Application Laid-open No. 2004-45591 and Japanese Patent Application Laid-open No. 2008-281901 can be used as the voice recognition technique.

The condition recognition unit 22 recognizes current conditions of the user on the basis of a detection result of a detection sensor such as the GPS receiving unit 13, information externally input, and the information stored in the storage unit 17. The current conditions of the user include external conditions, behavioral conditions, and available data conditions.

The external conditions are the conditions related to the environment in which the user is present, such as a current location of the user, and weather, temperature, and time at the location. The condition recognition unit 22 recognizes the current location of the user of the NA 10 using radio waves from GPS satellites received by the GPS receiving unit 13. The condition recognition unit 22 requests the search request unit 23, which is described later, to search the web for weather, temperature, or time on the basis of the recognized current location of the user, and recognizes the weather, the temperature, or the time at the current location of the user from the search result of the web search acquired by the search result acquisition unit 24, which is described later.

The behavioral conditions are conditions related to the behaviors of the user, such as “the user is walking”, “the user is on a train”, “the user is in a conversation”, “the user reaches over and grabs an orange”, “the user chimes in”, and “the user nods”. The condition recognition unit 22 recognizes the behavior such as “the user is walking” or “the user is on a train” on the basis of a temporal change in the positional information received by the GPS receiving unit 13.

The condition recognition unit 22 discriminates between transfer by train and walking on the basis of a moving velocity obtained from the temporal change in the positional information received by the GPS receiving unit 13. The condition recognition unit 22 may identify whether the moving route is on the road or the rail line by comparing the positional information with map information stored in the storage unit 17. As a result, the condition recognition unit 22 can discriminate between transfer by train and transfer by walking. The condition recognition unit 22 may discriminate between transfer by train and walking using a surrounding image taken by the imaging unit 18 and on the basis of the determination whether the image is of that in a train.

The condition recognition unit 22 recognizes that “persons are having a conversation” when voices of a plurality of persons are input on the basis of the voices input to the voice input unit 11. The condition recognition unit 22 may determine whether “persons are having a conversation” on the basis of whether an image taken by the imaging unit 16 includes a plurality of persons.

The condition recognition unit 22 recognizes that “the user reaches over and grabs an orange” on the basis of the image of the user taken by the imaging unit 16. Specifically, when the condition recognition unit 22 detects the movement of the user's hand in a direction away from the user's body from the captured moving image or still images in time series of the user, and additionally detects an orange at a position toward which the user's hand is moving, the voice recognition unit 21 recognizes that “the user reaches over and grabs an orange”. In the way described here, the voice input unit 11, the GPS receiving unit 13, and the imaging unit 16 function as the detection sensors detecting the external conditions.

The available data conditions are conditions of data formats of data capable of being provided to the user. In the embodiment, text data, image data, and voice data are assumed to be used as the data formats of data provided to the user. The NA 10 or other apparatuses than the NA 10 may provide the user with data.

For example, when the user has an apparatus provided with a speaker or the NA 10 provided with a speaker, data can be provided to the user by outputting the voice data from the speaker, whereas when the user does not have an apparatus provided with a display screen or the NA 10 provided with a display screen, data cannot be provided to the user as the text data and the image data.

The available data conditions are preliminarily stored in the storage unit 17. The condition recognition unit 22 recognizes the available data conditions with reference to the storage unit 17. For example, when the user has a smartphone, the condition recognition unit 22 recognizes that the voice data, the image data, and the text data can be output as the available data conditions. When the user does not have an apparatus provided with a speaker, the condition recognition unit 22 recognizes, as the available data conditions, that the voice data cannot be output. When the size of a display screen of an apparatus that the user has is small, the condition recognition unit 22 recognizes, as the available data conditions, that the image data cannot be output and only the text data can be output.

For another example, when data can be provided to the user using an output function of an apparatus, such as a public apparatus and a common use apparatus, other than an apparatus or the NA 10 that the user has, the condition recognition unit 22 also obtains, as the available data conditions, a condition recognition result of data formats capable of being provided by a usable output function. Specifically, the condition recognition unit 22 receives personal information of the user and information of the output function of an apparatus described in the map information of the surrounding area of the user's location from an external apparatus through the Internet 107, and acquires the condition recognition result of the output function of the apparatus other than the NA 10 on the basis of the received information. That is, the condition recognition unit 22 recognizes the available data conditions on the basis of the information input from the external apparatus.

The search request unit 23 acquires the voice recognition result obtained by the voice recognition unit 21 and condition recognition result obtained by the condition recognition unit 22, and makes a request to search information on the basis of the acquired results. For example, when acquiring the condition recognition result of “the user grabbing an orange” and the voice recognition result of “I want to know the freshness date”, the search request unit 23 requests the search server 101 to perform a web search with the search query of “the freshness date of an orange”.

The search result acquisition unit 24 acquires a search result corresponding to the search query from the search server 101 through the communication unit 15. When the search result is the map information, the search result acquisition unit 24 acquires the text data indicating an address, the voice data for voice guidance, the image data indicating a map, and/or the like.

The provision manner determination unit 25 determines a manner of providing a search result to the user, i.e., an output manner of the search result, on the basis of the condition recognition result. The provision manner determination unit 25 may acquire the necessary information through the Internet 107 and determine the provision manner taking into consideration the acquired information.

Specifically, the provision manner determination unit refers to a provision manner determination table stored in the storage unit 17 and determines the provision manner to the user on the basis of the condition recognition result. The provision manner determination unit 25 functions as an output manner determination unit.

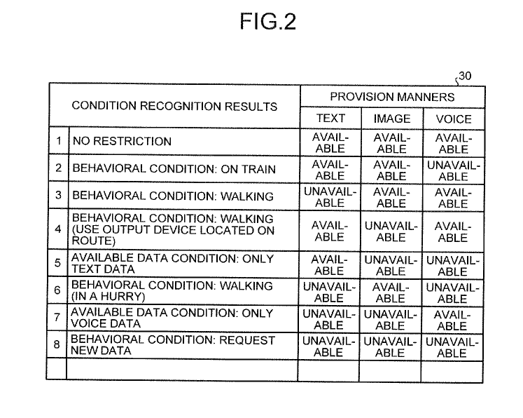

FIG. 2 is a schematic diagram illustrating a data structure of a provision manner determination table 30. The provision manner determination table 30 stores therein the condition recognition results and available provision manners so as to correspond to each other. The provision manner determination table 30 is preliminarily set in the storage unit 17 by a designer or the like.

As illustrated in condition recognition result 1, when the condition recognition result is no restriction, all of the text data, the image data, and the voice data can be provided to the user. Condition recognition result 1 corresponds to a case where the user has an apparatus capable of outputting any of the text data, the image data, and the voice data such as a smartphone, and is in a park, for example.

As illustrated in condition recognition result 2, when the user is on a train, only the text data and the image data can be provided to the user. This is because setting of a manner mode is recommended and thus output of the voice data is inappropriate on a train.

As illustrated in condition recognition result 3, when the user is walking and has an apparatus capable of outputting all of the text data, the image data, and the voice data, only the image data and the voice data can be provided to the user. The data is provided to the user with an image and a voice as the comprehensible contents. As a result, the user can grasp the contents without having to stop walking.

As illustrated in condition recognition result 4, when the user is walking without having an apparatus having an output function, and an electronic bulletin board (display screen) provided with a speaker is located on a route, only the text data and the voice data can be provided to the user. In this case, the NA 10 transmits a search result to the electronic bulletin board through the Internet 107 so as to cause the electronic bulletin board to output the search result as the text and the voice data, thereby providing the user with the search result.

As illustrated in condition recognition result 5, when the data that can be provided to the user is only the text data, only the text data can be provided to the user. Condition recognition result 5 corresponds to a case where the display screen size of an apparatus that the user has is small, for example.

As illustrated in condition recognition result 6, when the user is walking in a hurry, only the image data can be provided to the user. In such a case, where the user is in a hurry, only the data format capable of readily and promptly transmitting contents to the user is available.

As for the recognition that the user is in a hurry, the condition recognition unit 22 understands “what time and where the user needs to go” on the basis of information such as a schedule that is registered on the storage unit 17, any apparatus in a web cloud environment accessible through the communication unit 15 as the personal information of the user, or the like. In addition, the condition recognition unit 22 recognizes whether the user is in a hurry on the basis of the current location of the user, the current time, a destination, and a scheduled arrival time at the destination.

As illustrated in condition recognition result 7, when the data that can be provided to the user is only the voice data, only the voice data can be provided to the user. As illustrated in condition recognition result 8, when the user requests new data different from the data to be provided to the user, the data to be provided to the user is not provided. This is because the user is considered no longer having an interest in the data to be provided.

The data illustrated in the provision manner determination table 30 is part of the data of the provision manner determination table 30. The provision manner determination table 30 stores therein in further detail the condition recognition results and the provision manners so as to correspond to each other.

As another example, the condition recognition unit 22 may determine the provision manner from the condition recognition result in accordance with an algorithm for determining the provision manner instead of using the provision manner determination table. In this case, the storage unit 17 stores therein the algorithm instead of the provision manner determination table. The storage area of the information that the condition recognition unit 22 refers to, such as the provision manner determination table and the algorithm, is not limited to the NA 10. The information may be stored in any apparatus in the web cloud environment accessible through the communication unit 15.

Referring back to FIG. 1, the output control unit 26 causes a designated output destination to output a search result in accordance with the output manner determined by the provision manner determination unit 25. For example, when causing the output unit 19 to output a voice, the output control unit 26 converts an answer sentence (search result) produced by the search result acquisition unit 24 into a voice by voice synthesis and causes the output unit 19 to output the voice. For another example, when causing a display screen serving as the output unit 19 to display an image thereon, the output control unit 26 converts an answer sentence (search result) into image drawing data and causes the output unit 19 to display the image on the screen. When it is determined that output is to be performed using an external apparatus as the output manner, the output control unit 26 transmits an answer sentence (search result) to the designated external apparatus through the communication unit 15. In this case, the search result is output by the designated external apparatus in a designated output format.

The output control unit 26 controls output timing on the basis of the condition recognition result. For example, when the condition recognition result of the user uttering something is obtained, the output control unit 26 determines the completion of the utterance as the output timing, and outputs an answer sentence of the search result after the completion of the utterance. When no output format capable of being provided is present as illustrated in condition recognition result 8 of the provision manner determination table 30, the output control unit 26 determines that it is not the output timing and performs no output. An algorithm for determining the output timing on the basis of the condition recognition result or a table in which the condition recognition result and a control manner of the output timing are included so as to correspond to each other is preliminarily stored in the storage unit 17. The output control unit 26 determines the output timing using the algorithm or the table.

All of the above units are not indispensable for the NA 10, and a part of the units may be omitted.

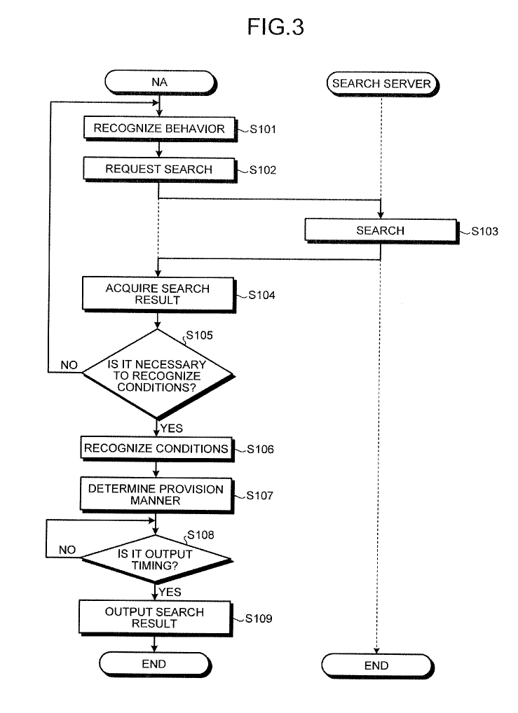

The operation of the processing system in the embodiment is described below. FIG. 3 is a flowchart illustrating an example of processing performed by the processing system 1 in the embodiment. The NA 10 always recognizes the behavior of the user (step S101). Specifically, the voice recognition unit 21 performs voice recognition processing each time a voice is input to the voice input unit 11 and the condition recognition unit 22 always recognizes the behavioral conditions of the user. The search request unit 23 produces a search query on the basis of the behavior recognition results obtained by the voice recognition unit 21 and the condition recognition unit 22 and requests the search server 101 to perform a search (step S102).

The search server 101 receives the search query from the NA 10, searches information published on the web in accordance with the received search query, and transmits the search result to the NA 10 (step S103).

The search result acquisition unit 24 acquires the search result of the information from the search server 101 (step S104). The condition recognition unit 22 determines that it is necessary to recognize the conditions when a certain behavioral recognition result is obtained (Yes at step S105), and obtains the condition recognition results on the external conditions and available data conditions on the basis of the detection result by the detection sensor, the information input externally, and the information stored in the storage unit 17 (step S106).

Examples of the behavioral recognition result determined that the conditions are required to be recognized are “the user says something” and “the user stands up”. The requirements that cause the condition recognition unit 22 to start recognizing the conditions are stored in the storage unit 17. The condition recognition unit 22 recognizes the conditions when the behavioral recognition result meeting the requirements stored in the storage unit 17 is obtained.

Examples of the behavioral recognition result determined that the conditions are not required to be recognized are “the user chimes in” and “the user nodes”. In the conditions in which those behaviors are observed, it is highly likely that no information needs to be provided.

The provision manner determination unit 25 refers to the provision manner determination table 30 and determines the provision manner of the search result to the user on the basis of the condition recognition result (step S107). The output control unit 26 determines whether it is the output timing on the basis of the condition recognition result. If it is determined that it is the output timing (Yes at step S108), the search result is output in the provision manner determined by the provision manner determination unit 25 (step S109).

When the data of the search result acquired by the search result acquisition unit 24 does not corresponds to the data format of the provision manner determined by the provision manner determination unit 25, the output control unit 26 converts the data of the search result into the data format of the provision manner determined by the provision manner determination unit 25. For example, when the image data and the voice data are acquired as the search result, the output control unit 26 converts the data of the search result into the text data when the text data is the determined provision manner (data format).

If it is determined that it is not the output timing (No at step S108), a wait is made until the output timing. The output control unit 26 determines whether it is the output timing as follows. For example, the output control unit 26 determines that it is not the output timing when the user has only an apparatus capable of outputting only the voice data and is on a train. After that, when the condition recognition result indicating that the user got off the train is obtained, the output control unit 26 determines that it is the output timing. As a result, the search result suspended from being provided is provided to the user.

If it is not determined that it is the output timing of the search result within a certain period of time at step S108, the output control unit 26 does not output the search result to the output unit 19 and the processing terminated. This enables the NA 10 to make no response when it is undesired that the NA 10 makes a response. As a result, the NA 10 can be prevented from hindering the conversation.

As described above, the processing system 1 in the embodiment can output the data in the output format appropriate for the user's condition. That is, the data can be provided in the format appropriate for the user's condition.

For example, when the NA 10 suddenly provides information in voices during a conversation between the users U1 and U2 on a train, it will disturb the surrounding people. In such a case, the processing system 1 in the embodiment can prohibit the voice output and instead display the image data or the text data on the display screen on a train. In this case, when a notification by vibration of a smartphone can be used, the image data or the text data may be displayed on the display screen together with the notification by vibration.

For another example, when the user is walking and the map information is provided to a mobile terminal of the user by a text mail, the user-friendliness deteriorates in that the user cannot readily understand the content because of the low visibility and the user needs to take out the mobile terminal. In such a case, the processing system 1 in the embodiment can provide the user with data, when a display capable of displaying a wide-area map is located on a walking route, by displaying the wide-area map on the display. As a result, the user can browse the desired wide-area map without having to stop walking.

The embodiment described above can be changed or modified in various ways.

As an example of the modification of the embodiment, setting information, history information, and feedback information from a user about the provision manner of information relating to one or more than one user of the NA 10 may be stored in the storage unit 17 as the personal information of the user. In this case, the provision manner determination unit 25 additionally refers to the personal information and determines the provision manner. As a result, the provision manner appropriate for the user can be determined. When the provision manner determined by the NA 10 is inappropriate for the user, the provision manner may be improved on the basis of a feedback from the user to that effect.

The NA 10 may store therein the condition recognition results and provision manners that the user desires as the personal information. When determining the provision manner from the next time onwards, the provision manner determination unit 25 may determine the provision manner by weighting the provision manners on the basis of the provided personal information.

The NA 10 in the embodiment has a normal hardware structure utilizing a computer. The NA 10 includes a control unit such as a CPU, a storage device such as a ROM and a RAM, an external storage device such as an HDD and a compact disk (CD) drive, a display device such as a display, and an input device such as a keyboard or a mouse.

The program executed by the NA 10 in the embodiment is recorded into a computer readable recording medium as a file in an installable format or an executable format, and provided. Examples of the recording medium include CD-ROMs, flexible disks (FDs), CD-recordables (CD-Rs), and digital versatile disks (DVDs).

The program executed by the NA 10 in the embodiment may be stored in a computer coupled with a network such as the Internet, and be provided by being downloaded through the network. The program executed by the NA 10 in the embodiment may be provided or delivered through a network such as the Internet. The program in the embodiment may be provided by being preliminarily stored in the ROM, for example.

The program executed by the NA 10 in the embodiment has a module structure including the above-described units (the behavior recognition unit, the environment recognition unit, the search request unit, the search result acquisition unit, the provision manner determination unit, and the output control unit). In actual hardware, the CPU (processor) reads the program from the storage medium and executes the program. Once the program is executed, the above-described units are loaded into a main storage, so that the units are formed in the main storage.

The embodiment can provide an advantage of providing the user with information in a provision manner fitting the user's condition.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A processing apparatus, comprising:
a voice recognition unit that recognizes a voice of a user;
a condition recognition unit that recognizes a current condition of a user;
a search result acquisition unit that acquires a search result searched on the basis of the voice recognized by the voice recognition unit;
an output manner determination unit that determines a manner of outputting the search result on the basis of the current condition recognized by the condition recognition unit; and
an output control unit that causes an output unit to output the search result acquired by the search result acquisition unit in the manner determined by the output manner determination unit.

2. The processing apparatus according to claim 1, wherein the current condition includes at least one of a behavioral condition of a user, an external condition, and a condition of a data format of data capable of being provided to a user.

3. The processing apparatus according to claim 1, wherein, when the search result acquisition unit acquires the search result, the condition recognition unit recognizes the current condition.

4. The processing apparatus according to claim 1, wherein,
when the output manner determination unit determines that no manner is available for outputting at the current condition, the condition recognition unit recognizes the current condition again after a certain period of time elapses, and
the output manner determination unit determines the manner on the basis of the current condition recognized again by the condition recognition unit.

5. The processing apparatus according to claim 1, wherein the output manner determination unit determines that the search result is to be output in at least one output format of image data, text data, and voice data as the manner.

6. A processing system, comprising:
a voice recognition unit that recognizes a voice of a user;
a condition recognition unit that recognizes a current condition of a user;
a search result acquisition unit that acquires a search result searched on the basis of the voice recognized by the voice recognition unit;
an output manner determination unit that determines a manner of outputting the search result on the basis of the current condition recognized by the condition recognition unit; and
an output control unit that causes an output unit to output the search result acquired by the search result acquisition unit in the manner determined by the output manner determination unit.

7. An output method, comprising:
recognizing a voice of a user;
recognizing a current condition of a user;
acquiring a search result searched on the basis of the voice recognized at the recognizing the voice;
determining a manner of outputting the search result on the basis of the current condition recognized at the recognizing the current condition; and
causing an output unit to output the search result acquired at the acquiring in the manner determined at the determining.
